(19) United States
(12) Patent Application Publication
(10) Pub. No.: US 2024/0127589 A1
(43) Pub. Date: Apr. 18, 2024

(54) HARDWARE FRIENDLY MULTI-KERNEL CONVOLUTION NETWORK

(71) Applicant: Samsung Electronics Co., Ltd., Gyeonggi-do (KR)

(72) Inventors: Qingfeng LIU, San Diego, CA (US); Mostafa EL-KHAMY, San Diego, CA (US); Sukhwan LIM, Los Altos Hills, CA (US)

(21) Appl. No.: 18/320,745

(22) Filed: May 19, 2023

Related U.S. Application Data
(60) Provisional application No. 63/416,781, filed on Oct. 17, 2022.

(51) Int. Cl. G06V 10/94; G06V 10/77; G06V 10/80; G06V 10/82

(52) U.S. Cl. CPC G06V 10/955; G06V 10/7715; G06V 10/806; G06V 10/82

(57) ABSTRACT

A system and a method are disclosed for processing and combining feature maps using a hardware friendly multi-kernel convolution block (HFMCB). The method including splitting an input feature map into a plurality of feature maps, each of the plurality of feature maps having a reduced number of channels; processing each of the plurality of feature maps with a different series of kernels; and combining the processed plurality of feature maps.

### CROSS-REFERENCE TO RELATED APPLICATION

This application claims the priority benefit under 35 U.S.C. § 119(e) of U.S. Provisional Application No. 63/416,781, filed on Oct. 17, 2022, the disclosure of which is incorporated by reference in its entirety as if fully set forth herein.

### TECHNICAL FIELD

The disclosure generally relates to a hardware friendly multi-kernel convolution network (HFMCN). More particularly, the subject matter disclosed herein relates to improvements to image signal processing based on the HFMCN.

### SUMMARY

Convolutional neural networks (CNNs) have provided a significant improvement in image processing efficiency and accuracy. Super resolution (SR), image noise reduction (NR), and/or temporal noise reduction (TNR) can each be performed using CNNs. However, the design of CNNs can be complex and computationally intensive, making them difficult to implement in hardware.

A challenge of image signal processing (ISP) design is to minimize computational costs. This may only be achieved if a single core network is used for all applications. However, the networks for SR, NR, and TNR are usually developed independently, with few shared design characteristics.

For instance, SR networks may use attention and dense connections without downsampling an input image, while NR networks may use a U-Net structure (U-shaped network connections between an encoder and decoder) that downsamples the input image.

To solve this problem, a general-purpose network called an HFMCN is disclosed, which can efficiently be used for one or more SR, NR, and TNR tasks. The HFMCN may be better suited than traditional network configurations for hardware implementation as well.

Another challenge in ISP is that the design of hardware-aware networks may limit the selection of network components. Certain components, like attention mechanisms, dilated convolutions, parametric rectified linear units (PReLU), and dense connections, which are widely used in SR and NR networks, are often inefficient in hardware. Furthermore, a high receptive field is usually associated with better performance in SR and NR, but current hardware design configurations may not support networks with a high receptive field, in order to reduce computational cost.

To overcome these challenges, a fundamental block of the disclosed general network, HFMCN, is introduced. This fundamental block is referred to as a hardware-friendly multi-kernel convolution block (HFMCB), which includes hardware-friendly operators. The HFMCB addresses the limitations of hardware-aware network design by providing a practical solution to efficiently implement image restoration (e.g., ISP) networks on hardware.

To overcome these issues, systems and methods are described herein to provide an SR, NR, and TNR system that is able to achieve state-of-the-art performance and complexity tradeoff.

The disclosure provides an HFMCB to obtain diverse features with different receptive fields. This can improve upon inefficient cascaded structure designs, and may be more suitable to efficiently utilize parallel processing. In addition, the operations inside the HFMCB may also be carefully chosen so that they are hardware friendly.

Additionally, the disclosure provides an HFMCN that stacks one or more HFMCBs to achieve an improved tradeoff between accuracy and complexity for multiple ISP processes, such as SR, NR, and TNR tasks.

In an embodiment, a method for processing and combining feature maps using an HFMCB is provided. The method including splitting an input feature map into a plurality of feature maps, each of the plurality of feature maps having a reduced number of channels; processing each of the plurality of feature maps with a different series of kernels; and combining the processed plurality of feature maps.

In an embodiment, an electronic device for processing and combining feature maps using an HFMCB is provided. The electronic device including at least one processor; and at least one memory operatively connected with the at least one processor, the at least one memory storing instructions, which when executed, instruct the at least one processor to perform a method of processing and combining the feature maps using the HFMCB, by splitting an input feature map into a plurality of feature maps, each of the plurality of feature maps having a reduced number of channels, processing each of the plurality of feature maps with a different series of kernels, and combining the processed plurality of feature maps.

In an embodiment, a method of applying an HFMCN to an input image using one or more HFMCBs is provided. The method includes applying a depthwise separable convolution function to the input image that increases a channel size of a feature map from a first number of channels to a second number of channels; applying the one or more HFMCBs to the feature map having the second number of channels, wherein applying the one or more HFMCBs includes splitting the feature map into a plurality of feature maps, each of the plurality of feature maps having a third number of channels that is less than the second number of channels, processing each of the plurality of feature maps with a different series of kernels, and combining the processed plurality of feature maps; and processing the combined plurality of feature maps using an application-specific layer (ASL) to output a processed output image.

### BRIEF DESCRIPTION OF THE DRAWING

In the following section, the aspects of the subject matter disclosed herein will be described with reference to exemplary embodiments illustrated in the figures, in which:

FIG. 1 illustrates an HFMCB, according to an embodiment;

FIG. 2 illustrates an information multi-distillation block (IMDB), according to an embodiment;

FIG. 3 illustrates an HFMCN, according to an embodiment;

FIG. 4 illustrates an HFMCN network design for an SR task, according to an embodiment;

FIG. 5 illustrates an HFMCN network design for an NR task, according to an embodiment;

FIG. 6 illustrates an HFMCN network design for a TNR task, according to an embodiment; and

FIG. 7 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

According to an embodiment, the present disclosure provides an HFMCB to obtain diverse features with different receptive fields. This can address the hardware-inefficient cascaded structure design, and may be more suitable for utilizing parallel processing. Additionally, the operations inside the HFMCB may be carefully chosen so that they are hardware friendly.

In addition, according to an embodiment, the present disclosure also provides an HFMCN that stacks HFMCBs to achieve an improved tradeoff of accuracy and complexity for multiple ISP processes, such as SR, NR, and TNR tasks.

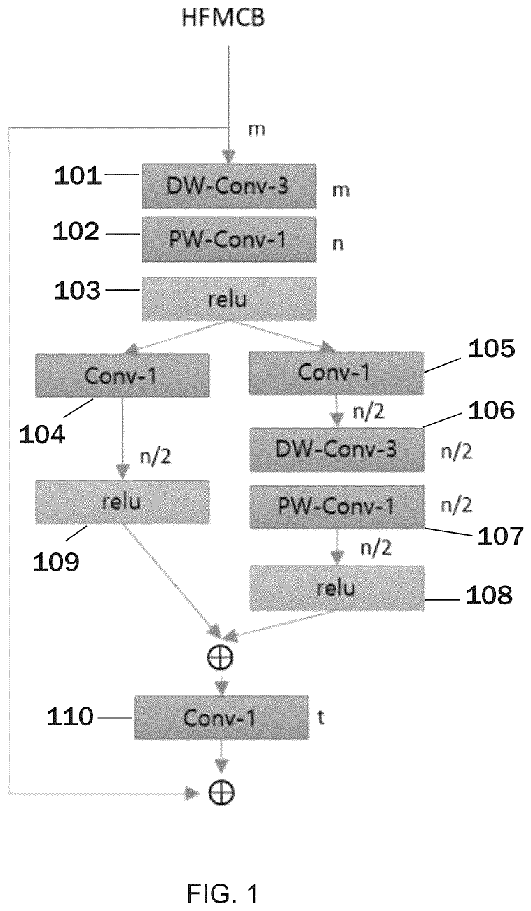

FIG. 1 illustrates an HFMCB, according to an embodiment.

An HFMCB may be implemented on hardware or software. For example, the HFMCB may be implemented on an input image obtained from a processor 700, camera 780, sensor 776, or another electronic device. One or more steps of the HFMCB may be instructed to be performed by a processor 720 (or a controller), and may be performed on an electronic device 701. Furthermore, the output of the HFMCB may be provided (e.g., transmitted) to additional processors or electronic devices for further processing.

Referring to FIG. 1, a detailed block design of an HFMCB is shown. (m,n,t) are defined as a tuple to describe the block. These parameters include the input channel size (m), the channel size of expansion (n), and the output channel size of each block (t). The tuple may be an ordered, immutable sequence of values.

For each input feature (e.g., for each input dataset), at step 101, depthwise separable convolution (e.g., a depthwise separable convolution routine or function) is applied as an expansion block with a 3×3 kernel size that increases the channel size of an input feature (e.g., a feature map) from m to n, and pointwise convolution with a 1×1 kernel size is performed at step 102. Depthwise convolution applies a separate filter to each input channel, creating a set of output feature maps, one for each input channel. A feature map may be an array (e.g., a two-dimensional array) of numbers that represent an output of a convolution layer.

By separating the operations of convolution into depthwise and pointwise stages, the number of parameters and computations required while still achieving high accuracy on tasks such as image classification, object detection, and semantic segmentation may be significantly reduced.

At step 103, a rectified linear unit (ReLU) is used as the activation function.

Thereafter, in steps 104 and 105, 1×1 convolution functions are applied at each step to divide the feature map into two groups along the channel dimension, where each branch has feature size (channel size) n/2.

In a first branch, at step 106, depthwise separable convolution and, at step 107, pointwise convolution are used to obtain a different receptive field of features from a second branch. Both branches apply ReLU as the activation function in step 108 for the first branch and step 109 for the second branch.

Finally, the two branches are summed together using an elementwise sum operation to form a merged feature followed by performing a 1×1 convolution function in step 110 to adjust the feature map size (channel size) to t. If the input and output channel size are the same, namely m=t, a skip connection (e.g., a residual connection) may be applied to allow information to bypass one or more layers in the network and be directly added to the output of deeper layers.

Accordingly, a plurality of feature maps may be processed with a different set of layers, in series, and each layer may be processed with a different kernel.

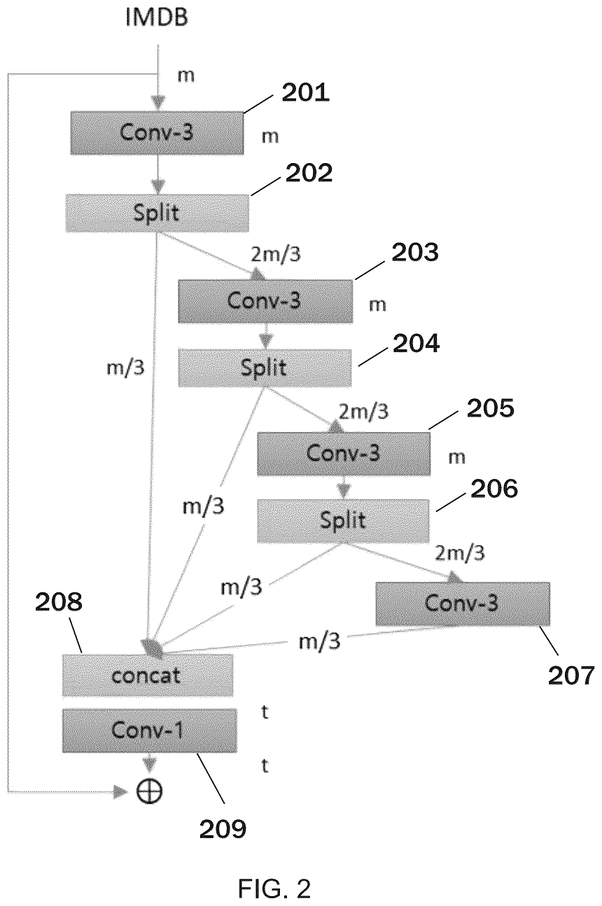

FIG. 2 illustrates an IMDB, according to an embodiment.

An IMDB may be implemented on hardware or software. For example, the IMDB may be implemented on an input image obtained from a processor 700, camera 780, sensor 776, or another electronic device. One or more steps of the IMDB may be instructed to be performed by a processor 720 (or a controller), and may be performed on an electronic device 701. Furthermore, the output of the IMDB may be provided (e.g., transmitted) to additional processors or electronic devices for further processing.

Referring to FIG. 2, hierarchical (cascading) features are extracted step-by-step, and then aggregated by using a 1×1 convolution operation. The cascading configuration illustrated in FIG. 2 may not be ideal for performing different ISP functions on hardware since 3×3 convolution (e.g., square convolution) performed in steps 201, 203, 205, and 207, and splitting performed in steps 202, 204, and 206 are performed in a hierarchal manner, thereby producing many different sets of data having different channel sizes (e.g., m, 2m/3, m/3, etc.). Combining these sets of data in a concatenation operation in step 208, performing a 1×1 convolution operation in step 209, and summing the data may be an inefficient hardware design for many ISP processes. Thus, the HFMCB and HFMCN disclosed herein provide an improved solution for hardware design for ISP processes.

Accordingly, the HFMCB disclosed herein may use a temporal difference network (TDN) and a wide residual network, with significant changes to an information multi-distillation network (IMDN). The HFMCB may use a 3×3 convolution function with a smaller expansion rate for improved computational cost and accuracy tradeoff, reducing the depth and increasing the width of the network to efficiently utilize hardware, and use depthwise separable convolution rather than normal convolution for improved efficiency. The HFMCB may also discard components that do not efficiently use hardware (e.g., components not friendly to hardware may be discarded), such as contrast-aware channel attention and cascading structure(s) inside the IMDB. Channel split operations and concatenation operations may be replaced with more hardware-friendly operations.

According to an embodiment, the HFMCB includes a series of blocks that are composed of 3×3 convolution and ReLU activation. The blocks also use a combination of depthwise separable convolution and 1×1 convolution to reduce computational cost and increase efficiency. The HFMCB also includes skip connections, which allow information to bypass one or more layers in the network and be directly added to the output of deeper layers for improved training and accuracy.

The HFMCB uses a basic idea from a TDN, in which an expansion convolution is used inside the block. However, instead of using 1×1 convolution, as in TDN, the HFMCB uses 3×3 convolution with a much smaller expansion rate for improved computational cost and accuracy tradeoff. The HFMCB also uses a wider residual network (ResNet) that reduces the depth of the network and increases the width of the network, which reduces the receptive field that is favored by hardware while still achieving improved results.

In addition, the HFMCB may be based on the IMDN, but includes significant changes to the original IMDN. The HFMCB may discard components that are not friendly to hardware, such as contrast-aware channel attention and cascading structure(s) inside the IMDB. The HFMCB may also replace channel split operations and concatenation with more hardware-friendly operations, such as two 1×1 convolutions to mimic the behavior of a channel split, and an elementwise sum operation to replace channel concatenation. Additionally, the HFMCB uses a rectified linear unit (ReLU) function rather than a parametric ReLU (PReLU), to reduce the amount of hardware resources that are consumed.

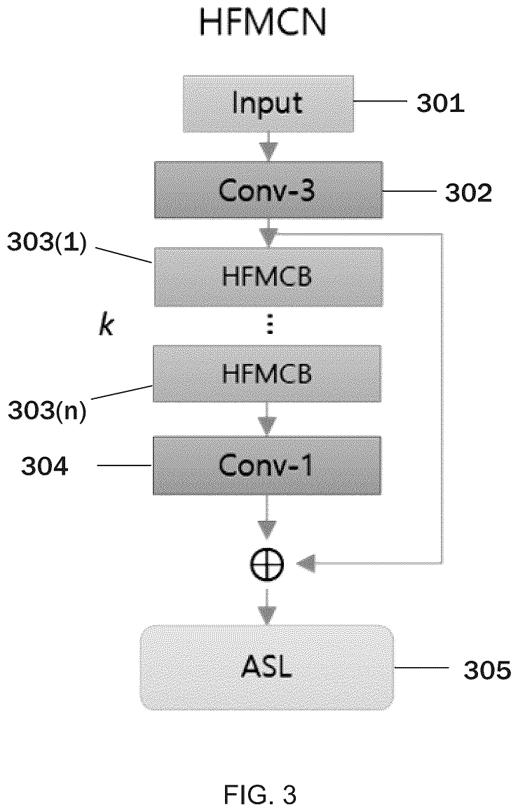

FIG. 3 illustrates an HFMCN, according to an embodiment.

An HFMCN may be implemented on hardware or software. For example, the HFMCN may be implemented on an input image obtained from a processor 700, camera 780, sensor 776, or another electronic device. One or more steps of the HFMCN may be instructed to be performed by a processor 720 (or a controller), and may be performed on an electronic device 701. Furthermore, the output of the HFMCN may be provided (e.g., transmitted) to additional processors or electronic devices for further processing. In addition, the HFMCN may include a number of HFMCB s, which are also implemented by hardware or software.

Referring to FIG. 3, the HFMCN is characterized by a tuple (m,n,t,k). These parameters indicate the input channel size of each HFMCB (m), the channel size of expansion (n), the output channel size of each block (t), and the number of times the HFMCBs are repeated (k).

An input image is provided at step 301. To process the input image, a convolution layer that extracts low-level features using a 3×3 convolution function is applied to the input image at step 302. These features may then use a skip connection before passing through an application-specific layer (ASL) if the input and output channel sizes are the same (e.g., m=t).

Next, a series of HFMCB blocks are stacked together in steps 303(1) to 303(n). Each HFMCB block may be equivalent to the HFMCB shown in FIG. 1. In this case, the number of HFMCB blocks that are stacked together may be k. For example, if 5 HFMCB blocks are stacked together, then k would be equal to 5, and five HFMCB operations would occur (303(1), 303(2), 303(3), 303(4), and 303(5)). At step 304, a 1×1 convolution function is applied to the output of the series of HFMCB blocks in steps 303(1) to 303(n).

Next, an ASL procedure is performed in step 305. The ASL procedure differs depending on the specific task being performed. For instance, subpixel upsampling is used in the ASL for an SR task, a 3×3 convolution block is used for an NR task, and a 3×3 convolution followed by a sigmoid layer is used for the ASL in a task related to TNR.

One advantage of using a common core network design for different tasks is that it is compatible with a wide variety of hardware designs and offers optimal complexity.

For example, an HFMCN network design for an SR task is provided below.

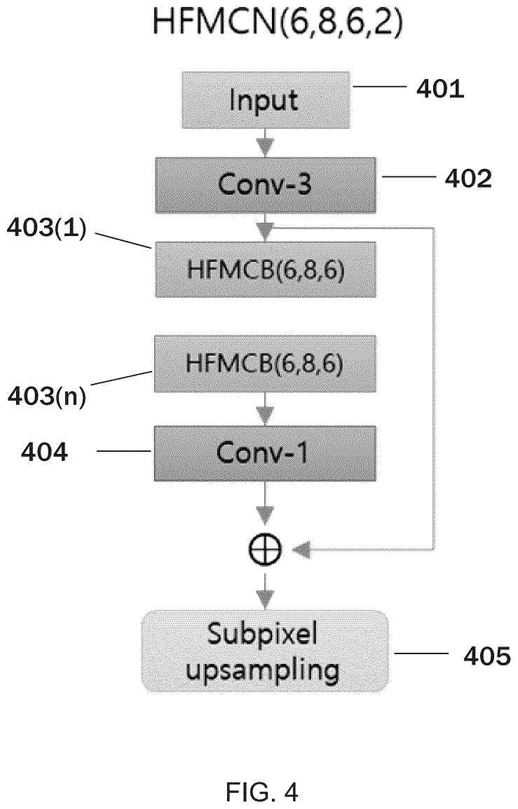

FIG. 4 illustrates an HFMCN network design for an SR task, according to an embodiment.

Referring to FIG. 4, a design of the HFMCN has a specific (m,n,t,k) configuration of (6,8,6,2). Steps 401, 402, 403(1) to 403(n), and 404 are respectively similar to steps 301, 302, 303(1) to 303(n) and 304 in FIG. 3, and descriptions of steps 401, 402, 403(1) to 403(n), and 404 may correspond to their respective counterparts in steps 301, 302, 303(1) to 303(n) and 304.

Step 405 refers to the ASL process (e.g., equivalent to step 305 in FIG. 3) after steps 401-404 are performed. However, in step 405, the ASL process in SR uses subpixel upsampling to improve performance.

Overall, the HFMCN network designed based on an SR process provides significant improvements over traditional SR processes.

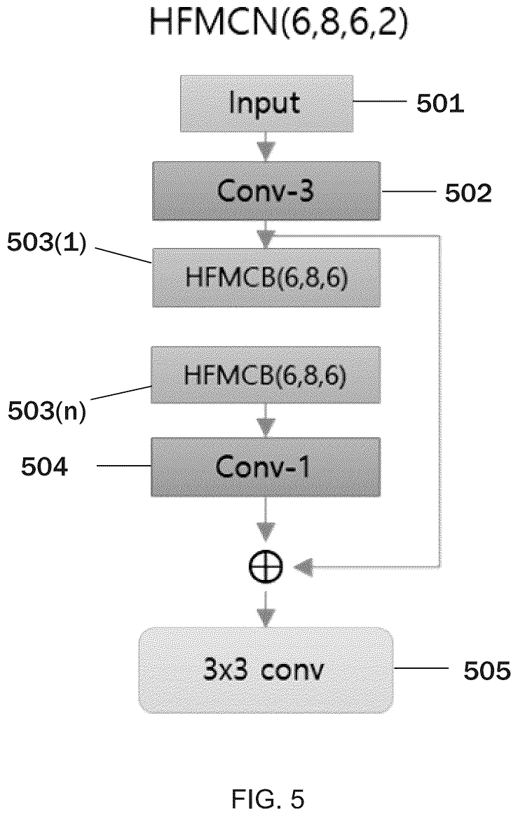

FIG. 5 illustrates an HFMCN network design for an NR task, according to an embodiment.

Referring to FIG. 5, a design of the HFMCN has a specific (m,n,t,k) configuration of (6,8,6,2). Steps 501, 502, 503(1) to 503(n), and 504 are respectively similar to steps 301, 302, 303(1) to 303(n) and 304 in FIG. 3, and descriptions of steps 501, 502, 503(1) to 503(n), and 504 may correspond to their respective counterparts in steps 301, 302, 303(1) to 303(n) and 304.

Step 505 refers to the ASL process (e.g., equivalent to step 305 in FIG. 3) after steps 501-504 are performed. However, in step 505, the ASL process in NR uses a 3×3 convolution process to improve performance.

In addition, an HFMCN design can be used for a TNR task. The TNR task may be equivalent to a fusion implementation. For example, an efficient multi-stage video denoising (EMVD) process can be configured using an HFMCN design.

EMVD is an efficient video denoising method which recursively uses a spatial temporal correlation inherently present in natural videos through processing stages applied in a recurrent fashion, such as temporal fusion, spatial denoising, and spatial-temporal refinement.

According to an embodiment, an HFMCN fusion implementation for performing a TNR task may include a color transformation stage, a frequency or inverse frequency transformation stage, and a fusion stage. In addition, the HFMCN may have four channel inputs and one channel output.

In the color transformation stage, an input image may be converted from a red green blue (RGB) dataset to a YUV dataset.

The frequency or inverse frequency transformation stage may include a decomposition step and a reconstruction step. The decomposition step may include transforming a single-channel input (represented by a YUV dataset) into a half-resolution four-channel feature map, using a wavelet_haar transformation.

The decomposition step may be performed using a 2×2 kernel size, stride 2 convolution process, which applies a 1×2×2×4 kernel to the input. This process may be based on biorthogonal wavelets and may be designed to decorrelate the input frequencies into four subbands. These subbands may include a low-pass subband (LL), and three high-pass subbands (LH, HL, and HH).

The resulting output of the wavelet_haar transformation may be a half-resolution 4-channel feature map, which can be used for further processing in the frequency or inverse frequency transformation stage.

The reconstruction step may include using a wavelet_haar_inverse function. This process may be used to recover the original resolution of the input signal, after it has been transformed into the four subbands using the wavelet_haar transformation.

The reconstruction step may include performing a 1×1 kernel size, stride 1 convolution using a 4×1×1×4 kernel. To recover the original resolution of the input signal, a subpixel upsampling technique may be applied. Subpixel upsampling may involve increasing the spatial resolution of an image by interpolating the values of neighboring pixels. In this case, the subpixel upsampling technique may be used to recover the original resolution of the input signal from its half-resolution representation in the four subbands.

In the fusion stage, an HFMCN may be used to obtain weights for fusion.

The HFMCN may have four channel inputs and one channel output.

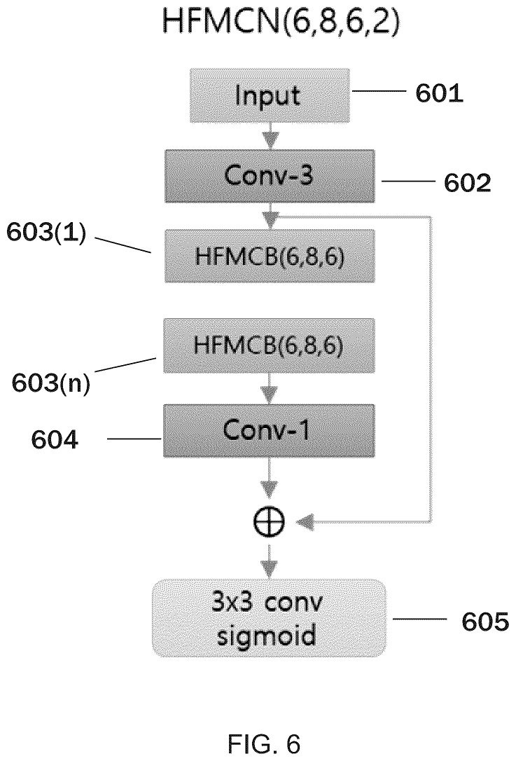

FIG. 6 illustrates an HFMCN network design for a TNR task (e.g., a fusion implementation), according to an embodiment.

Referring to FIG. 6, a design of the HFMCN has a specific (m,n,t,k) configuration of (6,8,6,2). Steps 601, 602, 603(1) to 603(n), and 604 are respectively similar to steps 301, 302, 303(1) to 303(n) and 304 in FIG. 3, and descriptions of steps 601, 602, 603(1) to 603(n), and 604 may correspond to their respective counterparts in steps 301, 302, 303(1) to 303(n) and 304.

Step 605 refers to the ASL process (e.g., equivalent to step 305 in FIG. 3) after steps 601-604 are performed. However, in step 605, the ASL process for the fusion task uses a 3×3 convolution sigmoid function to improve performance. The HFMCN network design of FIG. 6 may be less complex than traditional TDN network designs.

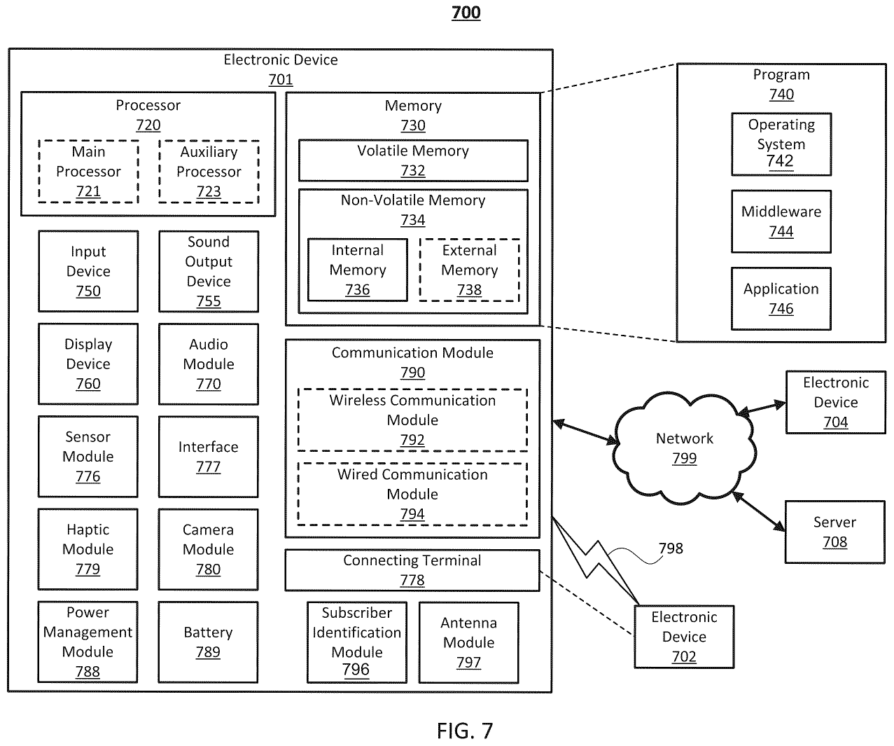

FIG. 7 is a block diagram of an electronic device in a network environment 700, according to an embodiment.

Referring to FIG. 7, an electronic device 701 in a network environment 700 may communicate with an electronic device 702 via a first network 798 (e.g., a short-range wireless communication network), or an electronic device 704 or a server 708 via a second network 799 (e.g., a long-range wireless communication network). The electronic device 701 may communicate with the electronic device 704 via the server 708. The electronic device 701 may include a processor 720, a memory 730, an input device 740, a sound output device 755, a display device 760, an audio module 770, a sensor module 776, an interface 777, a haptic module 779, a camera module 780, a power management module 788, a battery 789, a communication module 790, a subscriber identification module (SIM) card 796, or an antenna module 794. In one embodiment, at least one (e.g., the display device 760 or the camera module 780) of the components may be omitted from the electronic device 701, or one or more other components may be added to the electronic device 701. Some of the components may be implemented as a single integrated circuit (IC). For example, the sensor module 776 (e.g., a fingerprint sensor, an iris sensor, or an illuminance sensor) may be embedded in the display device 760 (e.g., a display).

The processor 720 may execute software (e.g., a program 740) to control at least one other component (e.g., a hardware or a software component) of the electronic device 701 coupled with the processor 720 and may perform various data processing or computations.

As at least part of the data processing or computations, the processor 720 may load a command or data received from another component (e.g., the sensor module 746 or the communication module 790) in volatile memory 732, process the command or the data stored in the volatile memory 732, and store resulting data in non-volatile memory 734. The processor 720 may include a main processor 721 (e.g., a central processing unit (CPU) or an application processor (AP)), and an auxiliary processor 723 (e.g., a graphics processing unit (GPU), an image signal processor (ISP), a sensor hub processor, or a communication processor (CP)) that is operable independently from, or in conjunction with, the main processor 721. Additionally or alternatively, the auxiliary processor 723 may be adapted to consume less power than the main processor 721, or execute a particular function. The auxiliary processor 723 may be implemented as being separate from, or a part of, the main processor 721.

The auxiliary processor 723 may control at least some of the functions or states related to at least one component (e.g., the display device 760, the sensor module 776, or the communication module 790) among the components of the electronic device 701, instead of the main processor 721 while the main processor 721 is in an inactive (e.g., sleep) state, or together with the main processor 721 while the main processor 721 is in an active state (e.g., executing an application). The auxiliary processor 723 (e.g., an image signal processor or a communication processor) may be implemented as part of another component (e.g., the camera module 780 or the communication module 790) functionally related to the auxiliary processor 723.

The memory 730 may store various data used by at least one component (e.g., the processor 720 or the sensor module 776) of the electronic device 701. The various data may include, for example, software (e.g., the program 740) and input data or output data for a command related thereto. The memory 730 may include the volatile memory 732 or the non-volatile memory 734.

The program 740 may be stored in the memory 730 as software, and may include, for example, an operating system (OS) 742, middleware 744, or an application 746.

The input device 750 may receive a command or data to be used by another component (e.g., the processor 720) of the electronic device 701, from the outside (e.g., a user) of the electronic device 701. The input device 750 may include, for example, a microphone, a mouse, or a keyboard.

The sound output device 755 may output sound signals to the outside of the electronic device 701. The sound output device 755 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 760 may visually provide information to the outside (e.g., a user) of the electronic device 701. The display device 760 may include, for example, a display, a hologram device, or a projector and control circuitry to control a corresponding one of the display, hologram device, and projector. The display device 760 may include touch circuitry adapted to detect a touch, or sensor circuitry (e.g., a pressure sensor) adapted to measure the intensity of force incurred by the touch.

The audio module 770 may convert a sound into an electrical signal and vice versa. The audio module 770 may obtain the sound via the input device 750 or output the sound via the sound output device 755 or a headphone of an external electronic device 702 directly (e.g., wired) or wirelessly coupled with the electronic device 701.

The sensor module 776 may detect an operational state (e.g., power or temperature) of the electronic device 701 or an environmental state (e.g., a state of a user) external to the electronic device 701, and then generate an electrical signal or data value corresponding to the detected state. The sensor module 776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 777 may support one or more specified protocols to be used for the electronic device 701 to be coupled with the external electronic device 702 directly (e.g., wired) or wirelessly. The interface 777 may include, for example, a high- definition multimedia interface (HDMI), a universal serial bus (USB) interface, a secure digital (SD) card interface, or an audio interface.

A connecting terminal 778 may include a connector via which the electronic device 701 may be physically connected with the external electronic device 702. The connecting terminal 778 may include, for example, an HDMI connector, a USB connector, an SD card connector, or an audio connector (e.g., a headphone connector).

The haptic module 779 may convert an electrical signal into a mechanical stimulus (e.g., a vibration or a movement) or an electrical stimulus which may be recognized by a user via tactile sensation or kinesthetic sensation. The haptic module 779 may include, for example, a motor, a piezoelectric element, or an electrical stimulator.

The camera module 780 may capture a still image or moving images. The camera module 780 may include one or more lenses, image sensors, image signal processors, or flashes. The power management module 788 may manage power supplied to the electronic device 701. The power management module 788 may be implemented as at least part of, for example, a power management integrated circuit (PMIC).

The battery 789 may supply power to at least one component of the electronic device 701. The battery 789 may include, for example, a primary cell which is not rechargeable, a secondary cell which is rechargeable, or a fuel cell.

The communication module 790 may support establishing a direct (e.g., wired) communication channel or a wireless communication channel between the electronic device 701 and the external electronic device (e.g., the electronic device 702, the electronic device 704, or the server 708) and performing communication via the established communication channel. The communication module 790 may include one or more communication processors that are operable independently from the processor 720 (e.g., the AP) and supports a direct (e.g., wired) communication or a wireless communication. The communication module 790 may include a wireless communication module 792 (e.g., a cellular communication module, a short-range wireless communication module, or a global navigation satellite system (GNSS) communication module) or a wired communication module 794 (e.g., a local area network (LAN) communication module or a power line communication (PLC) module). A corresponding one of these communication modules may communicate with the external electronic device via the first network 798 (e.g., a short-range communication network, such as Bluetooth™, wireless-fidelity (Wi-Fi) direct, or a standard of the Infrared Data Association (IrDA)) or the second network 799 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 792 may identify and authenticate the electronic device 701 in a communication network, such as the first network 798 or the second network 799, using subscriber information (e.g., international mobile subscriber identity (IMSI)) stored in the subscriber identification module 796.

The antenna module 797 may transmit or receive a signal or power to or from the outside (e.g., the external electronic device) of the electronic device 701. The antenna module 797 may include one or more antennas, and, therefrom, at least one antenna appropriate for a communication scheme used in the communication network, such as the first network 798 or the second network 799, may be selected, for example, by the communication module 790 (e.g., the wireless communication module 792). The signal or the power may then be transmitted or received between the communication module 790 and the external electronic device via the selected at least one antenna.

Commands or data may be transmitted or received between the electronic device 701 and the external electronic device 704 via the server 708 coupled with the second network 799. Each of the electronic devices 702 and 704 may be a device of a same type as, or a different type, from the electronic device 701. All or some of operations to be executed at the electronic device 701 may be executed at one or more of the external electronic devices 702, 704, or 708. For example, if the electronic device 701 should perform a function or a service automatically, or in response to a request from a user or another device, the electronic device 701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 701. The electronic device 701 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method of processing and combining feature maps using a hardware friendly multi-kernel convolution block (HFMCB), comprising:
splitting an input feature map into a plurality of feature maps, each of the plurality of feature maps having a reduced number of channels;
processing each of the plurality of feature maps with a different series of kernels; and
combining the processed plurality of feature maps.

2. The method of claim 1, wherein splitting the input feature map into the plurality of features maps comprises applying a 1×1 convolution function to reduce the number of channels for each of the plurality of feature maps.

3. The method of claim 1, wherein the reduced number of channels for each of the plurality of features maps are equal.

4. The method of claim 3, wherein combining the processed plurality of feature maps comprises applying a weighted sum of the plurality of feature maps.

5. The method of claim 1, wherein processing each of the plurality of feature maps comprises applying a depthwise separable convolution function to a proper subset of feature maps included in the plurality of feature maps.

6. The method of claim 1, wherein each of the plurality of feature maps are processed in parallel with the different series of kernels.

7. The method of claim 1, wherein each of the plurality of features maps include unique receptive fields.

8. An electronic device for processing and combining feature maps using a hardware-friendly multi-kernel convolution block (HFMCB), comprising:
at least one processor; and
at least one memory operatively connected with the at least one processor, the at least one memory storing instructions, which when executed, instruct the at least one processor to perform a method of processing and combining the feature maps using the HFMCB, by:
splitting an input feature map into a plurality of feature maps, each of the plurality of feature maps having a reduced number of channels,
processing each of the plurality of feature maps with a different series of kernels, and
combining the processed plurality of feature maps.

9. The electronic device of claim 8, wherein splitting the input feature map into the plurality of features maps comprises applying a 1×1 convolution function to reduce the number of channels for each of the plurality of feature maps.

10. The electronic device of claim 8, wherein the reduced number of channels for each of the plurality of features maps are equal.

11. The electronic device of claim 10, wherein combining the processed plurality of feature maps comprises applying a weighted sum of the plurality of feature maps.

12. The electronic device of claim 8, wherein processing each of the plurality of feature maps comprises applying a depthwise separable convolution function to a proper subset of feature maps included in the plurality of feature maps.

13. The electronic device of claim 8, wherein each of the plurality of feature maps are processed in parallel with the different series of kernels.

14. The electronic device of claim 8, wherein each of the plurality of features maps include unique receptive fields.

15. A method of applying a hardware friendly multi-kernel convolution network (HFMCN) to an input image using one or more hardware friendly multi-kernel convolution blocks (HFMCBs), the method comprising:
applying a depthwise separable convolution function to the input image that increases a channel size of a feature map from a first number of channels to a second number of channels;
applying the one or more HFMCBs to the feature map having the second number of channels, wherein applying the one or more HFMCBs comprises:
splitting the feature map into a plurality of feature maps, each of the plurality of feature maps having a third number of channels that is less than the second number of channels,
processing each of the plurality of feature maps with a different series of kernels, and
combining the processed plurality of feature maps; and
processing the combined plurality of feature maps using an application-specific layer (ASL) to output a processed output image.

16. The method of claim 15, wherein processing the combined plurality of feature maps using the ASL comprises, at least one of, applying a subpixel upsampling function to the combined plurality of feature maps, applying a square convolution function to the plurality of feature maps, or applying a square convolution sigmoid function to the plurality of feature maps to obtain the processed output image.

17. The method of claim 15, wherein applying the depthwise separable convolution function to the input image comprises applying a square convolution function to the input image to increase the channel size of the feature map from the first number of channels to the second number of channels.

18. The method of claim 15, wherein processing each of the plurality of feature maps comprises applying the depthwise separable convolution function to a proper subset of feature maps included in the plurality of feature maps.

19. The method of claim 15, wherein combining the processed plurality of feature maps comprises applying a weighted sum of the plurality of feature maps.

20. The method of claim 15, wherein each of the plurality of features maps include unique receptive fields.
